(19) United States
(12) Patent Application Publication
(10) Pub. No.: US 2026/0121130 A1
(43) Pub. Date: Apr. 30, 2026

(54) HIGH-DENSITY AD ULTRA-FAST ENERGY STORAGE DEVICES BASED ON MONOLAYERS OF METAL NANOPARTICLES AND OXIDE THIN FILMS

(71) Applicant: Khalifa University of Science and Technology, Abu Dhabi (AE)

(72) Inventors: Moh'd Rezeq, Abu Dhabi (AE); Hibah Shafeekali, Abu Dhabi (AE)

(21) Appl. No.: 19/365,925

(22) Filed: Oct. 22, 2025

Related U.S. Application Data
(60) Provisional application No. 63/711,287, filed on Oct. 24, 2024.

(51) Int. Cl. H01M 10/42; H01M 4/04; H01M 4/62; H01M 10/0525; H01M 10/44

(52) U.S. Cl. CPC H01M 10/4235; H01M 4/0426; H01M 4/62; H01M 10/0525; H01M 10/44; H01M 2220/30

(57) ABSTRACT

Disclosed are energy storage devices, methods of fabricating energy storage devices, and methods of charging and discharging the energy storage device. The energy storage device may include alternating layers of nanoparticle monolayers and insulating oxide layers. The energy storage device may have faster charging and discharging rates as compared to conventional energy storage devices.

### CROSS-REFERENCES TO RELATED APPLICATIONS

This application claims the benefit of U.S. Provisional Patent Application No. 63/711,287, filed Oct. 24, 2024, the entire contents of which are hereby incorporated by reference for all purposes in its entirety.

### FIELD OF THE INVENTION

The field of invention is related to nanotechnology, particularly to nanoparticle thin film systems, high density ultra-fast storage devices, and rapid charging and discharging memory cells.

### BACKGROUND OF THE INVENTION

Energy storage technologies are critical components in modern electronic systems, enabling efficient power management and supporting the growing demand for portable, high-performance devices such as mobile phones, laptops, and personal electronic devices. Conventional energy storage solutions, such as batteries and capacitors, typically rely on bulk materials and established electrochemical or dielectric mechanisms, which can present limitations in terms of energy density, charge/discharge rates, and device miniaturization. As advancements in technology and materials science have accelerated, there is increasing interest in leveraging novel material architectures and techniques to overcome these challenges.

### BRIEF SUMMARY OF THE INVENTION

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

Embodiments of the present disclosure include an energy storage device that includes a base substrate layer, a first metal layer deposited on a top surface of the base substrate layer, at least one oxide layer deposited on the top surface of the first metal layer, at least one nanoparticle layer deposited on a top surface of the at least one oxide layer, a discharge electrode deposited vertically along the at least one oxide layer and the at least one nanoparticle layer, an insulating layer deposited on a final layer of the at least one oxide layer, and a second metal layer deposited on a top surface of the insulating layer, and a discharging electrode. In some embodiments, the first metal layer is a bottom electrode. In other embodiments, the second metal layer is a top electrode. The at least one oxide layer and the at least one nanoparticle layer may be repeated at least 2 times to produce repeating layers of the at least one oxide layer and the at least one nanoparticle layer. In some embodiments, the oxide layer may be from 0.1 nm to 5.0 nm thick and produced from aluminum oxide (Al₂O₃), or other oxide layers. The at least one nanoparticle layer may be produced from nanoparticles having an average diameter of from 5 nm to 100 nm. The substrate layer may be an n-type substrate produced from silicon (Si), germanium (Ge), gallium nitride (GaN), gallium arsenide (GaAs), or silicon carbide (SiC). The first and second metal layer can be produced from or otherwise includes platinum, palladium, iridium, ruthenium, rhodium, cobalt nitrides, nickel, gold, or alloys produced therefrom.

In another aspect, provided herein are methods of fabricating energy storage devices. In some embodiments, the method may include depositing a metal base layer on a first side of a base substrate; depositing a thin film oxide layer on the metal base layer; spin coating or drop casting a colloidal gold nanoparticle monolayer on a top surface of the thin film oxide layer; repeating the steps of depositing of the thin film oxide layer and the casting of nanoparticles to produce alternate repeating layers of the thin film oxide layer and colloidal gold nanoparticle monolayer; depositing a discharge electrode on a side of the energy storage device; depositing an insulating layer a top surface of a final thin film oxide layer; and depositing a second metal layer on a top surface of the insulating layer. The discharge electrode comprises a thin oxide film layer positioned between the discharge electrode and the thin film oxide layers and colloidal gold nanoparticle layers. The discharge electrode is in electrical connection with the thin film oxide layers and the colloidal gold nanoparticle layers. In some embodiments, the insulating layer is in electrical connection with the final thin film oxide layer and the discharging electrode. In some embodiments, the deposition of the metal layer may include techniques such as physical vapor deposition or ion-sputtering techniques.

In yet another aspect, provided herein are methods of charging and discharging an energy storage device of the present disclosure. The method may include applying a voltage bias between the first metal layer and the second metal layer of the energy storage device as described herein; and connecting the energy storage device to an external electronic device. The top electrode is in physical contact with a negative polarity. The voltage bias reaches a threshold voltage to excite electrons inducing tunneling through the energy storage device to generate a stored charge. The connection to the external device causes a potential difference between the external electronic device and the energy storage device thereby transferring the stored charge from the energy storage device to the external electronic device.

Further aspects, objects, and advantages will become apparent upon consideration of the detailed description.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic of an energy storage device that incorporated monolayers of nanoparticles according to some aspects of the present disclosure.

FIG. 2 is a flowchart of an example of a process of fabricating an energy storage device comprising monolayers of nanoparticles distributed uniformly on oxide thin films according to some aspects of the present disclosure.

FIG. 3 is a schematic of a process used for forming an example energy storage device according to some aspects of the present disclosure.

FIG. 4 is a schematic of an example a dual layered nanoparticle energy storage device, according to some aspects of the present application.

FIG. 5 is a scanning electron microscope (SEM) image of a monolayer of nanoparticles formed on a semiconductor substrate according to some aspects of the present application.

### DETAILED DESCRIPTION

### I. Introduction

The development and widespread adoption of lithium-ion batteries (LIBs) have enabled significant advancements in portable electronics, electric vehicles, and large-scale energy storage systems. However, conventional LIBs present several well-recognized drawbacks that can limit their performance and safety. For example, the charging and discharging processes in these batteries are relatively slow and depend on the transport of lithium ions between the electrodes. This ion transfer can inflict considerable stress on both the electrode and electrolyte materials, often resulting in degradation over repeated cycles. Moreover, the organic electrolytes typically used in LIBs are flammable, which introduces notable safety concerns in the event of battery failure. The initial charging, or “forming” process, also leads to the irreversible consumption of a significant portion of lithium, as a solid-electrolyte interphase (SEI) forms on the anode surface, thereby reducing the overall efficiency and capacity of the battery.

In addition to these challenges, the formation of lithium dendrites, which are metallic lithium deposits that grow on the anode during repeated cycling, can further compromise battery integrity. These dendrites may eventually pierce the separator and cause internal short circuits, posing risks of catastrophic device failure or even fire. As a result, repeated use of lithium-ion batteries can accelerate material degradation and exacerbate the potential for dangerous malfunctions. In light of these limitations, alternative energy storage approaches that can overcome the inherent constraints of existing battery technologies. The present disclosure is directed toward exploring new material systems, device architectures, and mechanisms that may deliver safer, faster, and more reliable energy storage solutions for next-generation electronic applications. Provided herein is a type of energy storage device based on the trapping of electrons in monolayers of metal nanoparticles (NPs) which are isolated from each other with thin layers of oxides. The transfer (tunneling) of electrons between the NP layers may be facilitated by the high electric field on nanoparticles. Thus, the charging process may be fast and the device may be safer as there are no hazardous materials involved.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

Before the present disclosure is described in detail, it is to be understood that the terminology used herein is for purposes of describing particular examples and embodiments only, and is not intended to be limiting.

In this specification and in the claims that follow, reference will be made to a number of terms that shall be defined to have the following meanings:

### II. Definitions

Articles “a” and “an” are used herein to refer to one or to more than one (i.e., at least one) of the grammatical object of the article. By way of example, “an element” means at least one element and can include more than one element.

As used herein, the terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The terms “about” and “approximately” as used herein shall generally mean an acceptable degree of error for the quantity measured given the nature or precision of the measurements. Exemplary degrees of error are within 20% (%); preferably, within 10%; and more preferably, within 5% of a given value or range of values. Any reference to “about X” or “approximately X” specifically indicates at least the values X, 0.95X, 0.96X, 0.97X, 0.98X, 0.99X, 1.01X, 1.02X, 1.03X, 1.04X, and 1.05X. Thus, expressions “about X” or “approximately X” are intended to teach and provide written support for a claim limitation of, for example, “0.98X.” Numerical quantities given herein are approximate unless stated otherwise, meaning that the term “about” or “approximately” can be inferred when not expressly stated. When “about” is applied to the beginning of a numerical range, it applies to both ends of the range.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

### III. Device Structure

In one aspect, energy storage devices are provided herein that comprise nanoparticle monolayers in electrical and physical contact with oxide layers producing alternating layers of nanoparticles and oxide layers positioned between metal. In some embodiments, the energy storage device is a rechargeable device capable of withstanding constant cycling for as long, or longer when compared to lithium ion batteries. In some embodiments, the energy storage device may be used to charge electronic devices such as mobile phones, laptops, and other hand-held electronic devices.

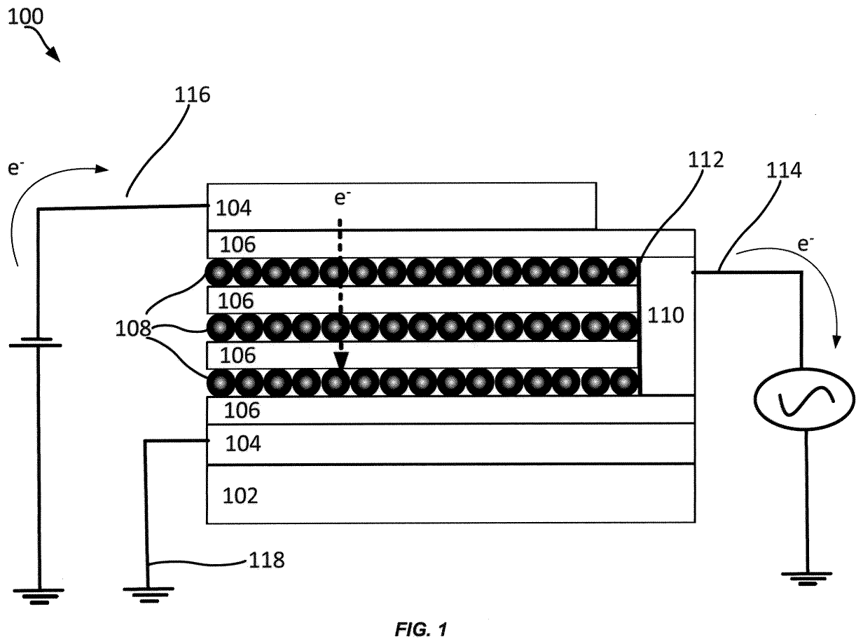

FIG. 1 is a schematic of an energy storage device 100 that incorporates monolayers of nanoparticles according to some aspects of the present disclosure. The energy storage device 100 can include a semiconductor substrate 102, two metal electrodes 104, and alternating oxide layers 106 and nanoparticles 108 positioned between the two metal electrodes. The energy storage device comprises a side electrode 110. In some embodiments, the energy storage device 100 may be fabricated to have a configuration comprising a bas substrate, wherein the base substrate is a semiconductor substrate 102, a first metal electrode 104 layer deposited on a top surface of the base substrate layer, at least one oxide layer 106 positioned on a top surface of a metal electrode 104 layer, at least one nanoparticle layer 108 deposited on a top surface of the oxide layer 106, a discharge electrode 110 deposited vertically along the at least one oxide layer 106 and at least one nanoparticle layer 108, an insulating layer 112 deposited between the discharge electrode 110 and the at least one oxide layer 106 and the at least one nanoparticle layer 108. The metal electrodes can be fabricated, as discussed below, using known microfabrication and nanofabrication techniques.

In some embodiments, the energy storage device 100 may include repeating layers of the at least one oxide layer 106 and the at least one nanoparticle layer 108 creating repeating alternate layers positioned between the two metal electrode 104 layers. In some embodiments, the discharge electrode 110 may be fabricated to span the length of the energy storage device 100 including the repeating layers of oxide layers 106 and nanoparticle layers 108. In some embodiments, the insulating layer 112, positioned between the discharge electrode 110 and the alternating layers of oxide film and nanoparticles, is produced from the same material as the at least one oxide layer 106. For example, the insulating layer 112 is from 0.5 nm to 2.0 nm thick and is produced from Al₂O₃. The insulating layer 112 may be fundamental to the device stability. For example, the thin oxide layer may aid in reducing unwanted discharge from the energy storage device 100. The insulating layer 112 maintains electrical isolation, ensuring controlled and safe discharge of stored energy and supports the overall reliability and performance of the device.

The architecture of the energy storage device 100 may be tuned to increase the energy storage density, improve the utilization of device volume, enhance the charge. discharge performance, and improve the device reliability and longevity.

Increasing the number of stacked monolayers of metal nanoparticle layers 108 and oxide layer 106 is a direct means of raising the total energy storage density of the device. Each monolayer of nanoparticles serves as a discrete region for trapping and storing electrical charge, isolated by thin oxide layers. By vertically integrating multiple monolayers, the device can accommodate a greater aggregate quantity of stored electrons, thereby scaling the total energy capacity. This additive effect enables the device to achieve a much higher energy density compared to single-layer or conventional structures, which is particularly advantageous for applications requiring compact and powerful energy storage solutions.

Stacking additional nanoparticle layers 108 and oxide layers 106 allows for more efficient utilization of the device's overall volume. Rather than expanding the lateral dimensions, which may not be feasible in miniaturized electronics, vertical stacking capitalizes on the third dimension to maximize storage within a constrained footprint. This approach is ideal for contemporary devices where space is at a premium, supporting the trend toward thinner, lighter, and more capable electronic products without sacrificing energy capacity.

The layered structure also significantly enhances charge and discharge performance. Electron tunneling between adjacent nanoparticle layers, facilitated by the high electric fields generated as each layer becomes fully charged, permits rapid cycling of charge throughout the stack. This mechanism is inherently faster than the ionic transport processes that dominate in traditional battery systems, enabling ultra-fast charging and discharging. As a result, devices employing multiple NP/oxide layers can deliver superior responsiveness and operational efficiency in demanding applications.

Finally, distributing charge storage across several layers contributes to improved device reliability and longevity. By spreading the stored electrons throughout the device, localized stresses and potential points of failure are mitigated, reducing the risk of material fatigue or catastrophic breakdown. Moreover, the absence of liquid electrolytes and the reliance on electron trapping rather than ion movement further diminishes the likelihood of electrochemical degradation, supporting longer service life and more consistent performance over repeated cycles.

In some embodiments, the energy storage device 100 may be described herein starting from a first base layer. In a first aspect, the semiconductor substrate 102 can include an n-type substrate or a metal substrate. In some embodiments, the n-type substrate may be silicone and may be further coated with a thin silicon dioxide layer. Silicon substrates are widely used in the fabrication of energy storage devices, especially in advanced applications involving nanostructures and thin films. The electrical properties of silicon can be tailored by doping with specific elements, resulting in either n-type or p-type silicon. These two types differ fundamentally in their charge carrier dynamics, which in turn influence the performance, reliability, and functional characteristics of energy storage devices built upon them.

N-type silicon substrates generally exhibit higher electrical conductivity than p-type substrates, primarily due to the greater mobility of electrons compared to holes. The Fermi level in n-type silicon lies closer to the conduction band, which can facilitate more efficient electron injection and rapid charge transfer at device interfaces. As a result, devices employing n-type substrates may benefit from enhanced performance in applications that rely on fast electron transport, such as those exploiting tunneling phenomena for ultra-fast charge and discharge cycles. Additionally, the electron-rich interfaces of n-type silicon can interact differently with deposited materials, including metal nanoparticles and oxide thin films, potentially leading to improved tunneling currents and charge retention.

In some embodiments, the n-type substrate, used for the semiconductor substrate 102, may be produced other materials including germanium (Ge), gallium nitride (GaN), gallium arsenide (GaAs), or silicon carbide (SiC). In some embodiments, the semiconductor substrate 102, may be produced from silicon dioxide (SiO₂). In some embodiments, the n-type substrate may be further doped to increase the charge transfer characteristics of the material.

In yet other embodiments, the semiconductor substrate 102, may be replaced by a metal substrate. In such configurations, the first metal electrode layer may be omitted from the device. The semiconductor substrate 102 may act as the first electrode surface when it is produced from a metal substrate. In some embodiments, the metal substrate, replacing the n-type silicon substrate may include platinum, palladium, iridium, ruthenium, rhodium, cobalt nitrides, nickel, gold, or alloys produced therefrom.

By contrast, p-type silicon substrates, with their hole-rich character and Fermi level positioned nearer the valence band, may be better suited for applications where hole transport is advantageous or where specific chemical interactions at the surface are desired. The different majority carrier type can also influence the formation and stability of interfacial layers, potentially affecting long-term cycling stability and device reliability. Ultimately, the selection between n-type and p-type silicon should be guided by the intended charge transport mechanism, compatibility with other device materials, and the specific performance objectives of the energy storage device. Proper substrate engineering is therefore a critical parameter in the design and optimization of advanced energy storage technologies.

In some embodiments, the n-type substrate can include a resistivity of 0.1-10 Ω·cm. For example, the silicon substrate can include a resistivity of at least 0.1 Ω·cm, at least 0.2 Ω·cm, at least 0.3 Ω·cm, at least 0.4 Ω·cm, at least 0.5 Ω·cm, at least 0.6 Ω·cm, at least 0.7 Ω·cm, at least 0.8 Ω·cm, at least 0.9 Ω·cm, at least 1.0 Ω·cm, at least 2.0 Ω·cm, at least 3.0 Ω·cm, at least 4.0 Ω·cm, at least 5.0 Ω·cm, at least 6.0 Ω·cm, at least 7.0 Ω·cm, at least 8.0 Ω·cm, at least 9.0 Ω·cm, or up to 10.0 Ω·cm. In some embodiments, the n-type substate is a silicon substrate having a resistivity as mentioned herein.

In some embodiments, the semiconductor substrate 102 can have a thickness of from 0.05 micrometers to 600 micrometers (μm). For example, the semiconductor substrate 102 is from 0.05 μm to 500 μm thick, from 0.06 μm to 400 μm thick, from 0.07 μm to 300 μm thick, from 0.08 μm to 200 μm thick, from 0.09 μm to 200 μm thick, from 0.10 μm to 100 μm thick, from 0.20 μm to 90 μm thick, from 0.30 μm to 80 μm thick, from 0.40 μm to 100 μm thick, from 0.50 μm to 90 μm thick, from 0.60 μm to 80 μm thick, from 0.70 μm to 70 μm thick, from 0.80 μm to 60 μm thick, from 0.90 μm to 50 μm thick, or from 1.0 μm to 40 μm thick. In some embodiments, the semiconductor substrate 102 may be fabricated as a nano device and thus may have a thickness of less than 1.0 μm.

In some embodiments, the energy storage device 100 may include an insulating layer positioned between the semiconductor substrate 102, and the metal electrode 104. For example, the insulating layer may be silicone oxide, aluminum oxide, or any other insulating layer known by those skilled in the arts. The thin insulating layer may act as a barrier between the metal electrode 104 and the semiconductor substrate 102. In some embodiments, the insulating layer may be placed in the device in leu of the metal electrode 104. For example, the device may include a semiconductor substrate 102 followed by an insulating layer and subsequently the repeating layers of nanoparticles 108 and the oxide layer 106.

In some embodiments, the energy storage device 100 includes a metal electrode 104. In some embodiments, the metal electrode 104 may be positioned on a top surface of the semiconductor substrate 102. In some embodiments, the metal electrodes 104 may be produced from metals commonly used in battery fabrication and energy storage devices. For example, the metal electrode 104 layers can be produced from platinum, palladium, iridium, ruthenium, rhodium, cobalt nitrides, nickel, gold, or alloys produced therefrom. In some embodiments, the discharge electrode 110 may be produced from the same or different metal material used for the metal electrode 104 layers.

In some embodiments, the metal electrode 104 layers may have a variable thickness depending upon the fabrication size of the energy storage device. For example, the metal electrodes 104 may be thin electrodes (e.g., from 10 nm to 30 nm) moderate thickness (e.g., from 30 nm to 100 nm), or may be high thickness (e.g., greater than 100 nm). The thin electrodes may be used in instances where the profile of the device is to be minimized, to support rapid electron tunneling, or to reduce material costs. Similarly, the moderately thick electrodes may be used to enhance the mechanical strength and stability of the device, may lower the sheet resistance, and may improve reliability over repeated cycling. In some embodiments, the metal electrodes 104 may be from 10 nm to 500 nm (e.g., from 10 nm to 500 nm, from 20 nm to 400 nm, from 30 nm to 300 nm, from 40 nm to 200 nm, or from 50 nm to 100 nm).

As described previously, the energy storage device 100 may include at least one oxide layer 106. In some embodiments, the oxide layer 106 may be positioned on a top surface of the metal electrode surface and the first nanoparticle layer 108. In some embodiments, the energy storage device 100 includes an oxide layer 106 positioned on a top surface of the first nanoparticle layer 108. The first nanoparticle layer 108 may be positioned on a top surface of the metal electrode 104 surface such that the nanoparticles are in direct electrical contact with the metal electrode 104 layer.

In some embodiments, the at least one oxide layer 106 may serve as an insulating barrier between the metal nanoparticle layers 108 and the metal electrodes 104. In some embodiments, the oxide layer 106 may be produced from or otherwise include aluminum oxide (Al₂O₃). The inclusion of an ultra-thin aluminum oxide (Al₂O₃) layer 106 between nanoparticle layers 108 in high-density energy storage devices offers several advantages that directly impact device performance and reliability. First, the Al₂O₃ layer may act as an effective electrical insulator, preventing direct contact and unwanted charge transfer between adjacent layers of metal nanoparticles. By physically and electronically separating these layers, the oxide film enables the device to trap and confine electrons within each nanoparticle monolayer, thereby supporting robust charge storage and minimizing leakage currents.

Additionally, the precise thickness and dielectric properties of the aluminum oxide layer are engineered to facilitate quantum mechanical tunneling of electrons when a sufficient electric field is applied. In this context, tunneling refers to the phenomenon where electrons can pass through the thin insulating barrier, not by classical conduction, but by exploiting quantum effects, allowing for rapid and controlled movement of charge between layers. This tunneling process is inherently faster than ionic transport mechanisms found in traditional batteries, resulting in ultra-fast charge and discharge cycles. The Al₂O₃ layer thus plays a dual role as it provides essential electrical isolation to ensure discrete charge trapping, while also enabling efficient electron tunneling for high-speed energy transfer. These combined benefits are fundamental to achieving the improved energy density, responsiveness, and safety profile of next-generation nanoparticle-based energy storage devices.

In some embodiments, the oxide layer 106 may be produced from other known oxides for use in solid-state energy storage devices such as the one described herein. In some embodiments, the at least one oxide layer 106 may be from 0.1 nm to 5.0 nm thick. For example, the at least one oxide layer 106 may be from 0.1 nm to 5.0 nm, from 0.5 nm to 4.5 nm, from 1.0 nm to 4.0 nm, or from 1.5 nm to 3.0 nm. In some embodiments, the at least one oxide layer may be less than 5.0 nm thick, less than 4.5 nm, less than 4.0 nm, less than 3.5 nm, or less than 3.0 nm thick.

The energy storage device 100, as previously mentioned, includes at least one nanoparticle layer 108 positioned on a top surface of the oxide layer 106 or on the metal electrode 104 layer. In some embodiments, the nanoparticle layer 108 may be produced from a monolayer of gold nanoparticles (Au-NPs). Au-NPs may be used due to their self-assembly ability into well-defined structures. Self-assembled nanoparticles capitalize on noncovalent interactions like van der Waals forces, hydrogen bonding, and electrostatic interactions to form ordered arrays. The chemistry behind this self-assembly often involves surface modification with ligands that induce specific interactions, promoting controlled and predictable assembly. This process is crucial for applications requiring precise nanoscale architectures, such as in the fabrication of highly sensitive sensors, enhancement of catalytic processes, and the development of photonic devices. The deposition method of the nanoparticles onto the surface may impact the uniformity of the monolayer-such phenomenon may be discussed in more detail below.

Similarly, the nanoparticle diameter may directly correlate to the formation of the monolayer used in the energy storage device 100. The gold nanoparticle monolayer may be produced from nanoparticles having diameter of from 5 nm to 100 nm. For example, the nanoparticles may have an average diameter of 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

Other advantages of nanoparticles for use in energy storage devices such as the one described herein, includes increased surface area for charge storage, enhanced electric field strength, control over the monolayer formation, and tailoring of the device properties. For example, Smaller diameter nanoparticles provide a dramatically higher surface area-to-volume ratio compared to larger particles or bulk materials. This expanded surface area enables more sites for electron trapping and storage, directly contributing to an increased energy storage density within a given device volume. As energy storage in these devices is primarily a surface phenomenon, where electrons are trapped on or near the nanoparticle surfaces, using nanoparticles of smaller diameters may maximize the overall charge capacity of the device.

Further, the electric field at the surface of a nanoparticle may be inversely related to its diameter; smaller nanoparticles exhibit higher localized electric fields for a given amount of stored charge. This elevated electric field is crucial in facilitating quantum mechanical tunneling of electrons across the ultra-thin oxide barriers separating the monolayers. Stronger local fields lower the effective barrier for tunneling, thereby increasing the tunneling current and enabling ultra-fast charge and discharge rates.

And finally, selecting nanoparticles of specific diameters, device designers can finely tune critical properties such as capacitance, operating voltage, and response time. Smaller nanoparticles generally support higher capacitance and faster operation, while larger particles may be advantageous in applications where stability or reduced leakage is prioritized. This tunability provides flexibility to optimize devices for a wide range of applications, from compact portable electronics to large-scale energy storage systems.

In some embodiments, the energy storage device 100, may include at least one layer of a metal thin film. The metal thin film may be deposited on the top surface of the nanoparticle layer before the deposition of the aluminum oxide layer. In some embodiments, the thin metal layer may be produced from platinum, palladium, iridium, ruthenium, rhodium, cobalt nitrides, nickel, gold, or alloys produced therefrom. In some embodiments the think metal layer may be from 1 nm to 500 nm (e.g., from 1 nm to 500 nm, from 20 nm to 400 nm, from 30 nm to 300 nm, from 40 nm to 200 nm, or from 50 nm to 100 nm). The thin metal layer may further enhance the lateral conductivity between the nanoparticles, thereby reducing charging and discharging time and increasing efficiency of the device. In some embodiments, the thin metal layer may be deposited on every top surface of the nanoparticle layers, just before the aluminum oxide layer.

In some embodiments, the energy storage device 100 includes a charging line 116 and a discharging line 114 for applying a voltage bias to the energy storage device. In some embodiments, the charging and discharging process may be described in more detail below. In some embodiments, the voltage bias applied through the charging line 116, once reaching a threshold voltage, electrons begin to tunnel, via quantum mechanics, from the metal electrode 104 at the top of the device, through the oxide layer 106 and into the nanoparticle layer 108. In some embodiments, this may be referred to as charge injection.

### IV. Fabrication Process

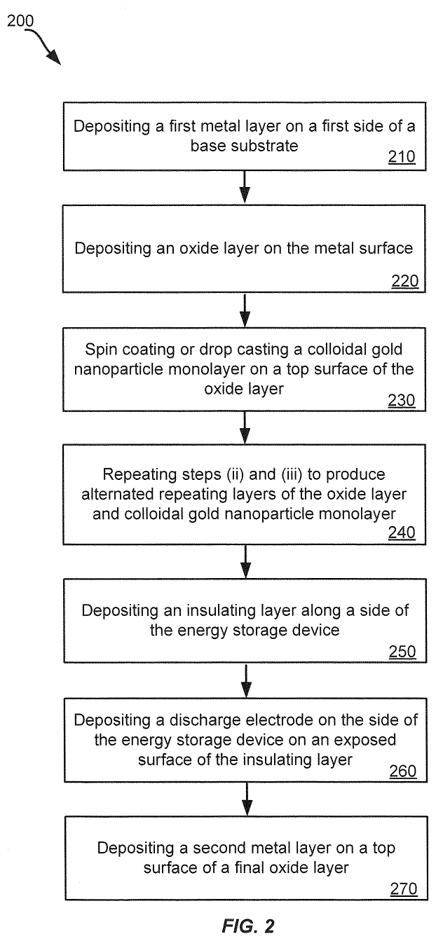

Provided herein are methods of fabricating an energy storage device 100 that is both carbon free and lithium free. In some embodiments, the energy storage device may be a rechargeable device. FIG. 2 is a flowchart of an example of a process 200 of fabricating an energy storage device comprising monolayers of nanoparticles distributed uniformly on oxide thin films according to some aspects of the present disclosure. Operations of processes may be performed by software, firmware, hardware, or a combination thereof. The operations of the process 200 start at block 210.

At block 210, the process 200 involves a depositing a metal layer on a first side of a base substrate. The base substrate may be an n-type substrate as described previously. The n-type substrate may be subsequently subject to deposition methods for depositing a base metal electrode layer. For example, the metal electrode layer may be produced from platinum, palladium, iridium, ruthenium, rhodium, cobalt nitrides, nickel, gold, or alloys produced therefrom.

Such deposition techniques may include physical vapor deposition (PVD) or ion sputtering. PVD is a cornerstone technique in the fabrication of high-performance metal electrode layers for advanced energy storage devices, including those utilizing nanoparticle monolayers and thin oxide films. The method may produce thin, uniform, and high-purity metal films with excellent adhesion to substrates such as silicon, silicon dioxide, and aluminum oxide. PVD processes, most commonly thermal evaporation or electron-beam (e-beam) evaporation, allow precise control over deposition parameters, ensuring reproducibility and scalability across research and industrial applications.

In a typical PVD workflow, the substrate (for example, a silicon wafer or an oxide-coated silicon) is first thoroughly cleaned and mounted in a vacuum chamber. The chamber may be evacuated to a base pressure in the range of 1×10⁻⁶ to 1×10⁻⁸ Torr to minimize the risk of contamination and ensuring that the deposited film is free from unwanted impurities. Once the desired vacuum level is reached, the source material, such as gold (Au), platinum (Pt), or silver (Ag) of at least 99.99% purity, is heated using either a resistive filament or an e-beam gun, causing the metal to vaporize and condense onto the substrate.

The deposition rate may be maintained between 0.1 and 2.0 nanometers per second (nm/sec). For ultra-thin electrode layers (such as those used in nanoparticle-based energy storage devices as described herein), a slower deposition rate may be employed. For example, the deposition rate may be from 0.2 to 0.5 nm/sec. In some embodiments, the slower rate may be used to promote film density and uniformity. Substrate temperature during deposition may be maintained at room temperature to 150° C., depending on the metal and desired adhesion. For example, gold electrodes may be heated to a narrower range of 25° C. to 80° C. to prevent substrate damage while enhancing film quality.

In some embodiments, the thickness of the deposition layer may be monitored to ensure adequate thickness is applied to the substrate surface. In some embodiments, the deposition layer may be monitored using real-time monitoring with a quartz crystal microbalance (QCM). QCM monitoring may allow for deposition of films in the target range of 10 to 100 nm. For example, a 20 nm gold electrode may be produced by evaporating at 0.2 nm/sec for 100 seconds, ensuring a dense, continuous film suitable for high-speed electron transport. Substrate rotation, typically set at 10 to 30 revolutions per minute (rpm), can be employed to further enhance film uniformity, especially for larger substrates or batch processes.

In some embodiments, to enhance the adhesion of the deposition layer to the substrate layer, a thin film may be deposited on the surface of the substrate prior to deposition of the metal electrode layer.

Ion sputtering may be employed to produce the metal electrode layer. In some embodiments, ion sputtering may be useful for metals such as gold (Au), platinum (Pt), and silver (Ag), which are frequently used as electrode materials due to their conductivity and chemical stability. In some embodiments, ion sputter deposition may begin by placing the cleaned substrate in a vacuum chamber. The chamber may be evacuated to a base pressure in the range of 1×10⁻⁴ to 1×10⁻⁸ Torr to remove contaminants and moisture, ensuring a pristine environment for film growth.

Once the base pressure is achieved, an inert gas may be introduced into the chamber to establish a working pressure between 1×10⁻³ and 5×10⁻³ Torr. For applications demanding particularly smooth and uniform films, a narrower working pressure range of 1.5×10⁻³ to 3×10⁻³ Torr may be selected. In some embodiments, the inert gas may be argon gas. The argon gas may be ionized by applying a voltage to the sputtering target (the metal to be deposited), creating a plasma. Positively charged argon ions may be accelerated toward the metal target, ejecting atoms from its surface. These atoms then condense onto the substrate, forming the electrode layer.

Key deposition parameters in ion sputtering may further include the sputtering power, which generally ranges from 10 to 200 Watts (W) for direct current (DC) or radio frequency (RF) magnetron systems. The target-to-substrate distance may be maintained between 5 and 15 centimeters (cm); for high uniformity. In some embodiments, a narrower distance may be employed. For example, from 7 to 10 cm. During sputtering, the substrate temperature may be maintained at room temperature (20° C. to 25° C.), but may be elevated up to 100° C. for enhanced adhesion or stress relief.

The deposition rate in ion sputtering may be from 0.05 to 1.0 nanometers per second (nm/sec). For ultra-thin, high-performance electrode layers, a rate of 0.1 to 0.3 nm/sec may be employed, yielding films with thicknesses precisely controlled between 10 and 100 nm. The process duration may be adjusted accordingly, and film thickness may be monitored.

At block 220, the process 200 involves depositing an oxide layer on the metal surface. In some embodiments, the oxide layer may be Al₂O₃. In some embodiments, the oxide layer may be manganese dioxide, cobalt oxide, nickel oxide, zinc oxide, titanium dioxide, silicon oxide, or any known oxide for use in energy storage devices. In some embodiments, the process for producing the Al₂O₃ layer may include atomic layer deposition (ALD) techniques. In some embodiments, the process for producing the oxide layer may include chemical vapor deposition.

Described herein is an example of an ALD process for preparing a device according to the methods described herein. For example, the ALD process may include first cleaning the substrate and subsequently loading the substrate into a dedicated ALD reactor. In some embodiments, the chamber conditions are controlled, with a deposition pressure set to approximately 200 millitorr (mTorr) and a growth temperature maintained at 200° C. In some embodiments, the deposition pressure and growth temperature may be changed depending on the precursor material and the substrate surface. In one non-limiting example, provided herein are parameters to optimize precursor reactivity and film uniformity while preserving substrate and device integrity for producing Al₂O₃ layers on a metal surface. For example, base pressures of 180 to 220 m Torr and the growth temperatures of 190° C. to 210° C. may be employed.

In some embodiments, the precursor trimethylaluminum (TMAl, Al(CH₃)₃) may be used as the metal-organic precursor, providing the aluminum source for the oxide film. A remote O₂ plasma may act as the co-reactant, supplying highly reactive oxygen species that facilitate the oxidation of TMAl and the formation of high-quality Al₂O₃. In some embodiments, the use of plasma enhances the growth rate and film quality, particularly at lower temperatures, and supports the production of dense, pinhole-free layers suitable for electron tunneling barriers.

ALD operates through sequential, self-limiting surface reactions, allowing for precise control over film thickness at the angstrom scale. The process parameters for TMAl exposure may include a first pulse, followed by a purge before the introduction of the O₂ plasma. In some embodiments, the pulse duration may be from 0.01 second to 1 seconds whereas the purge duration may be from 0.5 seconds to 10 seconds. These cycle timings are fine-tuned to reach an effective growth rate. In some embodiments the effective growth rate may be 1.2 angstroms (Å) per cycle. For example, to deposit a 1.5 nm Al₂O₃ layer, approximately 12 to 13 ALD cycles are performed, with each cycle contributing a highly controlled increment to the overall film thickness.

The high-k dielectric properties of AL₂O₃, combined with the atomic-scale thickness control provided by ALD, may result in a blocking oxide layer providing improved properties for use in devices described herein. This layer may function as an electrical insulator between nanoparticle monolayers or electrodes, preventing leakage currents and enabling quantum mechanical electron tunneling when a voltage bias is applied. The conformal coverage afforded by ALD ensures that even complex or high-aspect-ratio device geometries receive uniform oxide coatings, which is crucial for reliable device performance and longevity.

At block 230, the process 200 includes spin coating or drop casting a colloidal nanoparticle monolayer on a top surface of the oxide layer. In some embodiments, Drop casting may include a first step of preparing a concentrated and homogeneously dispersed Au—NP solution. For example, the solution may be first centrifuged at about 6000 rpm to increase the nanoparticle concentration. The precipitated fraction may be subjected to produce a uniform suspension and minimize aggregation. After achieving a well-dispersed solution, a small sample volume may be pipet onto the surface of the oxide layer. For example, the sample volume may be from 0.1 μL to 4 μL.

Immediately following deposition, the substrates may be placed in a high electric field setup. Application of a DC voltage across a defined gap between parallel plates influences the distribution and alignment of Au-NPs as the solvent evaporates, promoting the formation of a uniform monolayer. For example, applying a voltage of 250 V across a 0.7 cm gap generates an electric field of approximately 3.57×10⁴ V/m, while increasing the voltage to 500 V produces a field of 7.14×10⁴ V/m. Higher voltages, such as 750 V and 1000 V, yield even stronger fields, that may increase nanoparticle alignment and monolayer uniformity. The use of high electric fields during solvent evaporation is particularly effective for enhancing monolayer formation, as it drives nanoparticle migration and self-assembly into ordered domains.

Similarly, spin coating may be employed to produce the nanoparticle monolayer of the energy storage device. In spin coating, a measured volume of the nanoparticle solution may be dispensed onto the substrate and rapidly rotated. For example, rotated at speeds of from 1000 to 6000 rpm. The centrifugal force may subsequently spread the solution across the substrate surface, and the solvent evaporates quickly, leaving behind a thin, uniform monolayer of nanoparticles. For example, spin speeds of 4000 to 6000 rpm for 30 to 60 seconds may be utilized to achieve monolayers with high density and minimal defects. In some embodiments, the concentration of nanoparticles may be controlled. For example, the nanoparticle concentration may be from

$${10}^{6} \frac{nanoparticles}{ml} to {10}^{15} \frac{nanoparticles}{ml}$$

(e.g., from 10⁶ to 10¹⁴, from 10⁶ to 10¹³, from 10⁶ to 10¹², from 10⁸ to 10¹⁵, or from 10⁸ to

$${10}^{12} \frac{nanoparticles}{ml} .$$

In some embodiments, the nanoparticle concentration may be greater than

$${10}^{15} \frac{nanoparticles}{ml} .$$

The concentration of the nanoparticle solution, viscosity, and spin speed may be adjusted due to their influence on the final monolayer quality. For example, lower concentrations and higher spin speeds may produce thinner films, while higher concentrations and slower speeds may produce thicker or multi-layered structures. In some embodiments, the nanoparticles may be gold nanoparticles. In some embodiments, the gold nanoparticles may have an average diameter of from 5 nm to 100 nm. For example, the nanoparticles may have an average diameter of 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

At block 240, the process may include repeating the steps in block 220 and 230 to produce alternate repeating layers of the oxide layer and the colloidal gold nanoparticle monolayer. In some embodiments, the step at block 240 may be repeated from 2 times to more than 100 times to produce the energy storage device. For example, the energy storage device may have at least 5 layers of nanoparticles positioned between oxide layers. In some embodiments, the energy storage device may have at least 10 layers, at least 15 layers, at least 20 layers, at least 25 layers, at least 30 layers, at least 35 layers, at least 40 layers, at least 45 layers, at least 50 layers, at least 55 layers, at least 60 layers, at least 65 layers, at least 70 layers, at least 75 layers, at least 80 layers, at least 85 layers, at least 90 layers, at least 95 layers, at least 100 layers, or up to 200 layers. For example, the energy storage device may have from 2 to 1000 layers of the nanoparticle monolayers and oxide thin films. In some embodiments, the energy storage device may include greater than 200 layers of the nanoparticle monolayers and oxide thin films. In some embodiments, the energy storage device may include greater than 300 layers, greater than 400 layers, greater than 500 layers, greater than 600 layers, greater than 700 layers, greater than 800 layers, greater than 900 layers or greater than 1000 layers of the nanoparticle monolayers and oxide thin films.

At block 250, the process 200 includes depositing an insulating layer along a side of the energy storage device. In some embodiments, the insulating layer may be produced using the methods described herein for producing the oxide film. For example, the insulating film may be deposited using ALD according to the same parameters as provided above. In some embodiments, the thin insulating layer is produced along the length of the energy storage device and span the entire stack of alternate layers. The insulating layer may separate the discharge electrode from the alternating layers to reduce unwanted discharge and make the device safer.

At block 260, the process 200 includes depositing a discharge electrode onto the exposed surface of the insulating layer. The discharge electrode may be deposited according to the methods described above for depositing the metal electrodes. In some embodiments, the discharge electrode is produced from or includes the same material as the metal electrodes. For example, the discharge electrode may be platinum, palladium, iridium, ruthenium, rhodium, cobalt nitrides, nickel, gold, or alloys produced therefrom. The discharge electrode may be built vertically to be in physical and electrical contact with the entire stack of alternating monolayers.

Once the discharge electrode is fabricated on the energy storage device, a final oxide layer may be deposited on the final nanoparticle monolayer. The method of deposition of the final oxide layer may be the same as the deposition technique used for the previous oxide thin films. In some embodiments, the oxide thin films may have the same thickness across the entire device.

At block 270, the process 200 may include depositing a second metal layer on the top/exposed surface of the final oxide layer. In some embodiments, the deposition of the metal electrode may be performed according to the methods described in block 210. The metal electrode may be produced from platinum, palladium, iridium, ruthenium, rhodium, cobalt nitrides, nickel, gold, or alloys produced therefrom.

### Charging (Energy Storage) Discharging Processes

In some embodiments, the charge storage process may be performed by applying a voltage bias between the top and bottom metal electrodes. A voltage bias between two electrodes refers to the intentional application of a potential difference (voltage) across those electrodes within the electronic device. This means that one electrode is maintained at a higher (or lower) electrical potential relative to the other, creating an electric field between them. The term “bias” refers to the deliberate setting of this voltage, typically to control the direction and magnitude of current flow, initiate specific physical or chemical processes, or tune the operational characteristics of a device. In configurations described herein, the top electrode may be connected with the negative polarity while the bottom electrode is grounded or held at a positive potential. Such configuration may generate a strong electric field across the device stack, concentrated across each thin oxide layer.

Once a threshold voltage is reached, the electrons may tunnel from the top electrode, through the thin oxide layer, into the top nanoparticle monolayer. At a point when the top nanoparticle monolayer is fully charged, a high electric field may be generated on the nanoparticles. The charge then transfers through the proceeding layer and into the next nanoparticle layer. This tunneling occurs through the entire stack until all the monolayers of nanoparticles are fully charged. As the tunneling process is occurring, the stored charge on subsequent layers can screen the applied electric field, reducing the tunneling current in subsequent voltage sweeps. This screening effect may be an experimental signature of successful charge trapping and evidence that the device is functioning as an electron-storage medium, not just as an ohmic conductor.

Electron tunneling may be faster than ionic migration in conventional batteries, enabling rapid device charging. For example, a conventional ion migration in batteries may be from milliseconds to seconds. However, electron tunneling as described herein may occur in picoseconds to femtoseconds. Thus, the charging of the energy storage device described herein may be 10⁹ to 10¹² times faster than conventional ion batteries.

When charging of an electronic device is required, the energy storage device as described herein may be electrically connected to said electronic device. The energy storage device may discharge via the discharging electrode. Once connected, the stored charge on the NP monolayers are pulled, under the potential difference with the connected devices, through the thin oxide layer. The discharge of the device may occur faster than conventional ion batteries. For example, the discharge rate may be from picoseconds to milliseconds as compared to conventional batteries.

Specific details are given in the description to provide a thorough understanding of the embodiments. However, it will be understood that the embodiments may be practiced without these specific details. For example, specific computational models, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

In the preceding description, various embodiments have been described. For purposes of explanation, specific configurations and details have been set forth in order to provide a thorough understanding of the embodiments. However, it will also be apparent to one skilled in the art that the embodiments may be practiced without the specific details. Furthermore, well-known features may have been omitted or simplified in order not to obscure the embodiment being described. A person of skill in the art may understand that steps described above may be omitted, may be performed in an different order, or may include repeating steps described herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### EXAMPLES

The following examples are offered to illustrate, but not to limit, the present disclosure.

### Example 1. Fabrication of an Energy Storage Device and Subsequent Charging and Discharging

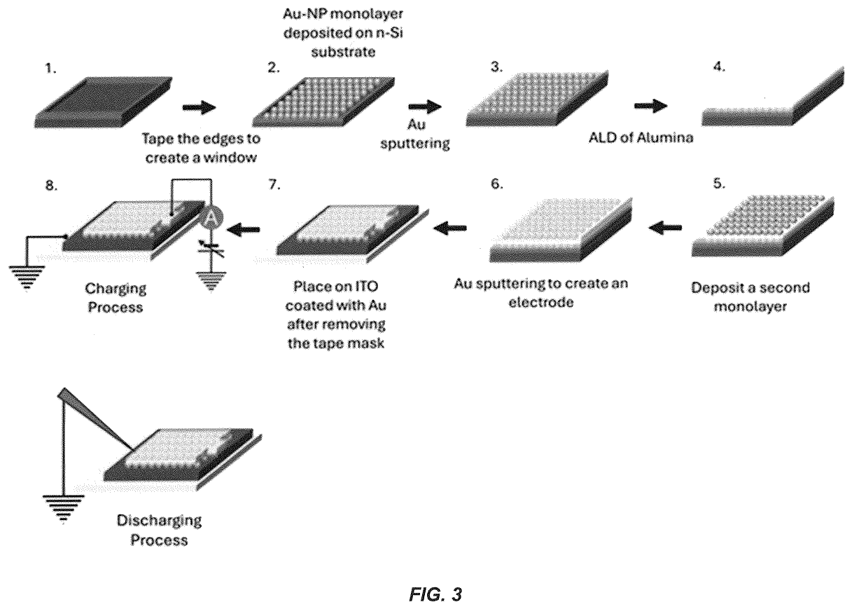

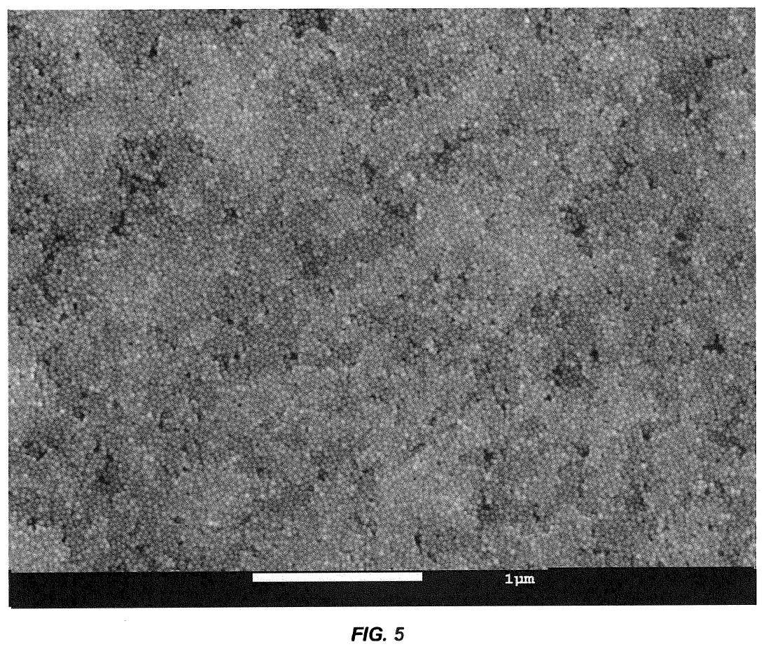

To demonstrate a device as described herein is functional, a working prototype was prepared that included a nanoparticle monolayer-based energy storage device. FIG. 3 is a schematic of a process used for forming an example energy storage device according to some aspects of the present disclosure. Briefly, a monolayer of gold nanoparticles (AuNPs) was first prepared on a 1 cm×1 cm silicon (Si) substrate with a resistivity of 5-10 Ω·cm. The edges of the Si substrate were initially covered with an insulating tape, such as Kapton tape, to avoid any contamination from the deposited materials during the fabrication process. The insulating tape can also be replaced by a patterned mask with the device design. The gold nanoparticles used had a diameter of 30 nm. Scanning electron microscopy can be employed to visualize the formation of the nanoparticle monolayer (FIG. 5) To enhance the conductivity between the gold nanoparticles, a thin gold layer was deposited on top of the NP monolayer using a sputtering process as previously described.

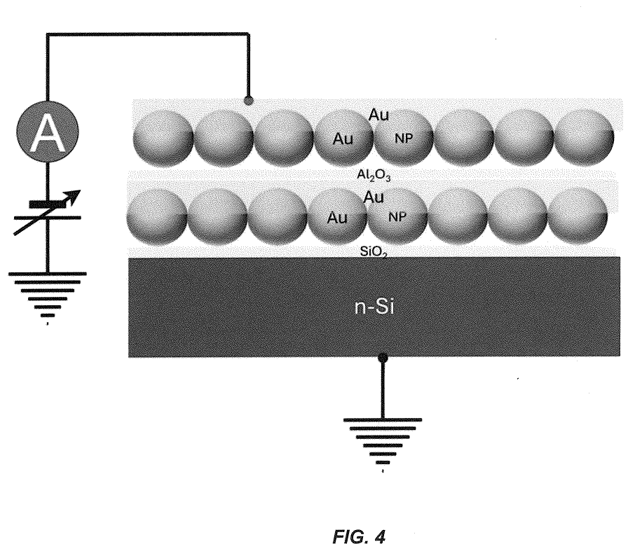

Next, the deposition of a thin insulating layer of aluminum oxide (Al₂O₃) (2-3 nm) was carried out on top of the device using the Atomic Layer Deposition System. Subsequently, A second gold nanoparticle (AuNP) monolayer was deposited on top of the alumina (Al₂O₃) layer to further enhance the local electric field and hence increase the tunneling current. Then, a thin gold layer was sputtered on top of the NPs monolayer to form the top electrode. The Kapton tape was carefully removed, leaving only a small portion in place to serve as a base for placing the top electrode without damaging the stack of layers of the device. For example, the device may be prepared having a base n-type silicon layer. Deposited on top of the n-type silicone was a silicon dioxide thin film. Deposited on top of the silicon dioxide was a monolayer of gold nanoparticles. The gold nanoparticles were sputtered with a layer of gold followed by a layer of aluminium oxide and a final layer of gold. The device depicted in FIG. 4 includes a second nanoparticle monolayer deposited on a top surface of the aluminium oxide layer followed by a gold layer sputtered on top of the nanoparticle monolayer to produce a dual layered energy storage device. The device was then mounted on a gold-coated indium tin oxide (ITO) plate to perform the I-V characterization.

A negative bias voltage was applied to the top electrode, while the bottom gold plate was connected to the ground. The I-V data showed that during the first voltage sweep from 0 to −5 V, the tunnelling current increased rapidly, after an applied voltage (−2.0 V), through the device stack (curve 1). The second voltage sweep showed a lower tunnelling current. A high voltage sweep is required from 0 to −8.0 V, and the current starts to increase at (−3.5 V), indicating that the charge stored in the first sweep is screening the applied field, resulting in less current (curve 2). Discharging the trapped charge by connecting the side of the gold NPs monolayer with a metal pen to the ground, then repeating the I-V measurements again, a similar I-V curve behaviour to the initial one (curve 1) was obtained in curve 3, indicating that the sample was completely discharged. The device was charged again after the last voltage sweep, as confirmed in curve 4.

A similar trend was observed during the charging process. For example, the I-V data showed that during the first voltage sweep from 0 to −5 V, the tunnelling current increased rapidly, after an applied voltage, through the device stack (first run). The second voltage sweep showed a lower tunnelling current. A high voltage sweep is required from 0 to −6.0 V, and the current starts to increase, indicating that the charge stored in the first sweep is screening the applied field, resulting in less current (second run). A higher voltage sweep is required from 0 to −8.0 V, and the current starts to increase at around-4.0 V, indicating that the charge stored in the first and second sweep is screening the applied field, resulting in less current (third run).

### V. References

(1) Nathaniel, S. P.; Alam, M.; Murshed, M.; Mahmood, H.; Ahmad, P., The roles of nuclear energy, renewable energy, and economic growth in the abatement of carbon dioxide emissions in the G7 countries. Environmental Science and Pollution Research 2021, 28 (35), 47957-47972.
(2) Bhattacharya, M.; Paramati, S. R.; Ozturk, I.; Bhattacharya, S. The effect of renewable energy consumption on economic growth: Evidence from top 38 countries. Applied Energy 2016, 162, 733-741.
(3) Kittner, N.; Lill, F.; Kammen, D. M. Energy storage deployment and innovation for the clean energy transition. Nature Energy 2017, 2 (9), 1-6.
(4) Dou, F.; Shi, L.; Chen, G.; Zhang, D., Silicon/carbon composite anode materials for lithium-ion batteries. Electrochemical Energy Reviews 2019, 2 (1), 149-198.
(5) Manthiram, A.; Goodenough, J. B., Layered lithium cobalt oxide cathodes. Nature Energy 2021, 6 (3), 323-323.
(6) Zheng, F.; Kotobuki, M.; Song, S.; Lai, M. O.; Lu, L., Review on solid electrolytes for all-solid-state lithium-ion batteries. Journal of Power Sources 2018, 389, 198-213.
(7) Whitehead, A. H.; Schreiber, M., Current collectors for positive electrodes of lithium-based batteries. Journal of The Electrochemical Society 2005, 152 (11), A2105.
(8) Rezk, A.; Abbas, Y.; Saadat, I.; Nayfeh, A.; Rezeq, M. Charging and discharging characteristics of a single gold nanoparticle embedded in Al₂O₃ thin films. Appl. Phys. Lett. 2020, 116, 223501.
(9) Rezeq, M.; Eledlebi Kh.; Ismail, M.; Dey, R. K.; Cui B. Theoretical and experimental investigations of nano-Schottky contacts. Journal of Applied Physics 2016, 120, 044302.
(10) Abbas, Y.; Rezk, A.; Anwer, S.; Saadat, I.; Nayfeh, A.; Rezeq, M. Improved figures of merit of nano-Schottky diode by embedding and characterizing individual gold nanoparticles on n-Si substrates. Nanotechology 2020, 31 (12), p. 125708.
(11) Firdous Ahmad Deader, Yawar Abbas, Ahsanulhaq Qurashi, Mahmoud Al-Qutayri, Vincent Chan, Moh′d Rezeq, “Electric Field-Driven Self-Assembly of Gold Nanoparticle Monolayers on Silicon Substrates” Langmuir 2023, 39, 44, 15766-15772.

What is claimed is:

1. An energy storage device comprising:
a base substrate layer;
a first metal layer deposited on a top surface of the base substrate layer, wherein the first metal layer is a bottom electrode;
at least one oxide layer deposited on a top surface of the first metal layer;
at least one nanoparticle layer deposited on a top surface of the at least one oxide layer;
a discharge electrode deposited vertically along the at least one oxide layer and the at least one nanoparticle layer;
an insulating layer deposited between the discharge electrode and the at least one oxide layer and the at least one nanoparticle layer; and
a second metal layer deposited on a top surface of the insulating layer, wherein the second metal layer is a top electrode.

2. The energy storage device of claim 1, wherein the at least one oxide layer and the at least one nanoparticle layer are repeated at least 2 times to produce repeating layers of the at least one oxide layer and the at least one nanoparticle layer.

3. The energy storage device of claim 1, wherein the at least one oxide layer is from 0.1 nm to 5.0 nm thick.

4. The energy storage device of claim 3, wherein the oxide layer is comprised of Aluminum oxide (Al₂O₃).

5. The energy storage device of claim 1, wherein the at least one nanoparticle layer comprises nanoparticles having a diameter of from 5 nm to 100 nm.

6. The energy storage device of claim 1, wherein the base substrate layer is an n-type substrate or a metal substrate.

7. The energy storage device of claim 6, wherein the n-type substrate is silicon (Si), germanium (Ge), gallium nitride (GaN), gallium arsenide (GaAs), silicon carbide (SiC), or Silicon dioxide (SiO₂).

8. The energy storage device of claim 1, wherein the first metal layer and the second metal layer are produced from platinum, palladium, iridium, ruthenium, rhodium, cobalt nitrides, nickel, gold, or alloys produced therefrom.

9. A method of fabricating an energy storage device comprising:
(i) depositing a first metal layer on a first side of a base substrate;
(ii) depositing an oxide layer on the first metal layer;
(iii) spin coating or drop casting a colloidal gold nanoparticle monolayer on a top surface of the oxide layer;
(iv) repeating steps (ii) and (iii) to produce alternate repeating layers of the oxide layer and colloidal gold nanoparticle monolayer;
(v) depositing an insulating layer along a side of the repeating layers to produce a thin film oxide layer, wherein the thin film oxide layer is in electrical connection with a discharge electrode and the repeating layers of oxide layers and nanoparticle layers;
(vi) depositing a discharge electrode on the side of the energy storage device on an exposed surface of the insulating layer, wherein the discharge electrode is in electrical connection with the repeating layers of the oxide layer and the colloidal gold nanoparticle monolayer; and
(vii) depositing a second metal layer on a top surface of a final oxide layer.

10. The method of claim 9, wherein the depositing of the first metal layer and the second metal layer is carried out using physical vapor deposition or ion-sputtering techniques.

11. The method of claim 10, wherein the first metal layer and the second metal layer are produced from platinum, palladium, iridium, ruthenium, rhodium, cobalt nitrides, nickel, gold, or alloys produced therefrom.

12. The method of claim 9, wherein the thin film oxide layer is deposited using atomic layer deposition systems or chemical vapor deposition systems.

13. The method of claim 9, wherein the thin film oxide layer is comprised of Aluminum oxide (Al₂O₃).

14. The method of claim 13, wherein the thin film oxide layer is from 0.1 nm to 5.0 nm thick.

15. The method of claim 9, wherein step (iv) is repeated from 2 to 1000 times.

16. The method of claim 9, wherein the colloidal gold nanoparticle monolayer comprises nanoparticles having a diameter of from 5 nm to 100 nm.

17. The method of claim 9, wherein the base substrate is an n-type substrate or a metal substrate.

18. The method of claim 17, wherein the n-type substrate is silicon (Si), germanium (Ge), gallium nitride (GaN), gallium arsenide (GaAs), silicon carbide (SiC), or Silicon dioxide (SiO₂).

19. A method of charging and discharging an energy storage device comprising;
applying a voltage bias between the first metal layer and the second metal layer of the energy storage device of claim 1, wherein the top electrode is in physical contact with a negative polarity, wherein the voltage bias reaches a threshold voltage to excite electrons, wherein excited electrons tunnel through the energy storage device to generate a stored charge;
connecting the energy storage device to an external electronic device, wherein the connection causes a potential difference between the external electronic device and the energy storage device thereby transferring the stored charge from the energy storage device to the external electronic device.

20. The method of charging and discharging the energy storage device of claim 19, wherein the external electronic device is a mobile phone, a computer, a tablet, or other personal electronic device.
